(19) United States
(12) Patent Application Publication
(10) Pub. No.: US 2004/0015429 A1
(43) Pub. Date: Jan. 22, 2004

(54) Bet matching system

(76) Inventors: Joseph Michael Tighe, London (GB); Graham Kennedy Twaddle, Argyll and Bute (GB)

Correspondence Address: FINNEGAN, HENDERSON, FARABOW, GARRETT & DUNNER, LLP, 1300 I STREET, NW, WASHINGTON, DC, 20005, US

(21) Appl. No.: 10/275,068

(22) PCT Filed: Sep. 18, 2001
(86) PCT No.: PCT/GB01/04170

(30) Foreign Application Priority Data
Sep. 18, 2000 (GB) 0022862.7

(51) Int. Cl. G06F 17/60

(52) U.S. Cl. 705/37

(57) ABSTRACT

A bet matching system receives data representative of a bet placed on the outcome of an event such as a sporting match. The data includes the odds which a user wishes to take in terms of probability units, and a stake. A relational database system is arranged to match the bet against an earlier or later opposing bet, or bets, on the reverse outcome by looking for a match within the contra odds for the bet.

This invention relates to bet matching systems. In particular the invention relates to bet matching systems for matching bets over a communication network, for example the Internet. The invention has particular, although not exclusive, relevance to bets on current events such as sporting events, for example, soccer, cricket, boxing, motor racing, horse racing etc., or political elections and so on.

Recently a number of Internet based betting services have become available in which a client is able to place a bet backing a particular outcome of an event, for example a particular team winning a particular football match at an odds selected by the client. The system is arranged to locate a matching bet by a further client laying that particular outcome, that is a client having the opposite view on the outcome of the event who effectively “acts as the bookmaker” offering odds against the particular team winning. If the particular team does win, the first client recovers his stake together with his stake times the selected odds on the team winning from the second client. Conversely if the particular team loses or draws, the further client laying the outcome recovers his stake and takes the first client's stake. Settling of bets is thus between the pairs of clients having matched bets. In order to finance the system, the bet matching system operator will generally take either a fixed sum, or a percentage of the stake from one or both of the clients.

The matching of bets may be performed by arranging for bets placed by various clients to be displayed on a web page such that a subsequent potential client may see the current unmatched bets and choose to match one of the current unmatched bets, the system enabling contact to be made between pairs of clients placing matched bets.

Alternatively, as described in UK Patent Application GB-A-2356071, the bet matching system may include a computer system configured to match automatically bets which back and lay a given outcome. This avoids the necessity for the pair of clients to come into contact with each other and enables the current client's bet to be matched against existing unmatched bets to the client's best advantage, that is at the most favourable odds to the current client. This encourages use of the system.

When the bet matching system allows bets to be placed during an event, such as a football match, an occurrence such as a rapid sequence of goals by a previously poorly rated team may cause a large number of clients to want to place new bets within a short period of time. Some clients may wish to place counter bets to their previous bets in order to ameliorate their position, assuming that a matching bet can be found. Such an arrangement creates great demands on the computer system to enable an acceptable matching speed to be achieved.

It is an object of the present invention to provide a flexible bet matching system in which bets backing an outcome are automatically matched with bets backing a reverse outcome, the bet matching system being capable of handling a large amount of traffic between a large number of users who may be in a number of different locations and using a variety of communication means. It is a further object of the present invention that clients may be able to obtain an indication of the odds on bets which have previously been matched.

According to a first aspect of the present invention there is provided a bet matching system comprising:

means for receiving data representative of a bet placed on the outcome of an event;

means for storing data relating to the placed bet in a relational database,

means for determining whether the odds on any earlier stored bets on the reverse outcome are the same or greater than those of the current bet and if so forming a match between said bet and said earlier stored data bet for at least part of the stake; and means for storing the bet in respect of any unmatched part of the stake for matching against future bets.

Further aspects of the invention provide a method of use of a bet matching system and a computer program containing processor readable instructions for performing such a method.

An embodiment of a bet matching system in accordance with the invention will now be described by way of example only with reference to the accompanying drawings in which:

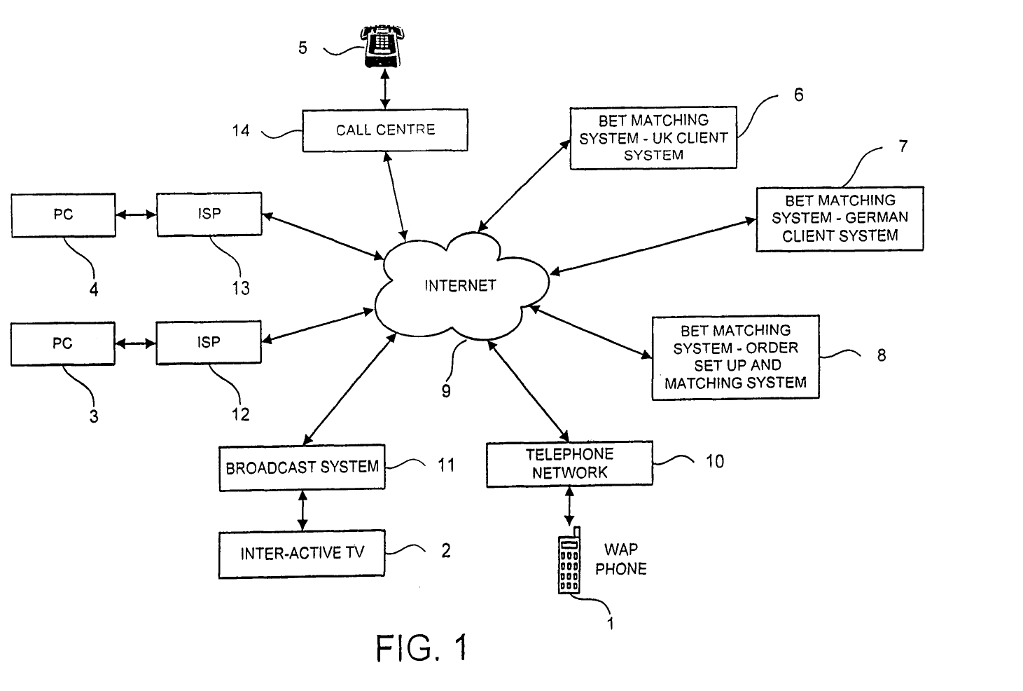

FIG. 1 depicts an overview of the bet matching system in operation;

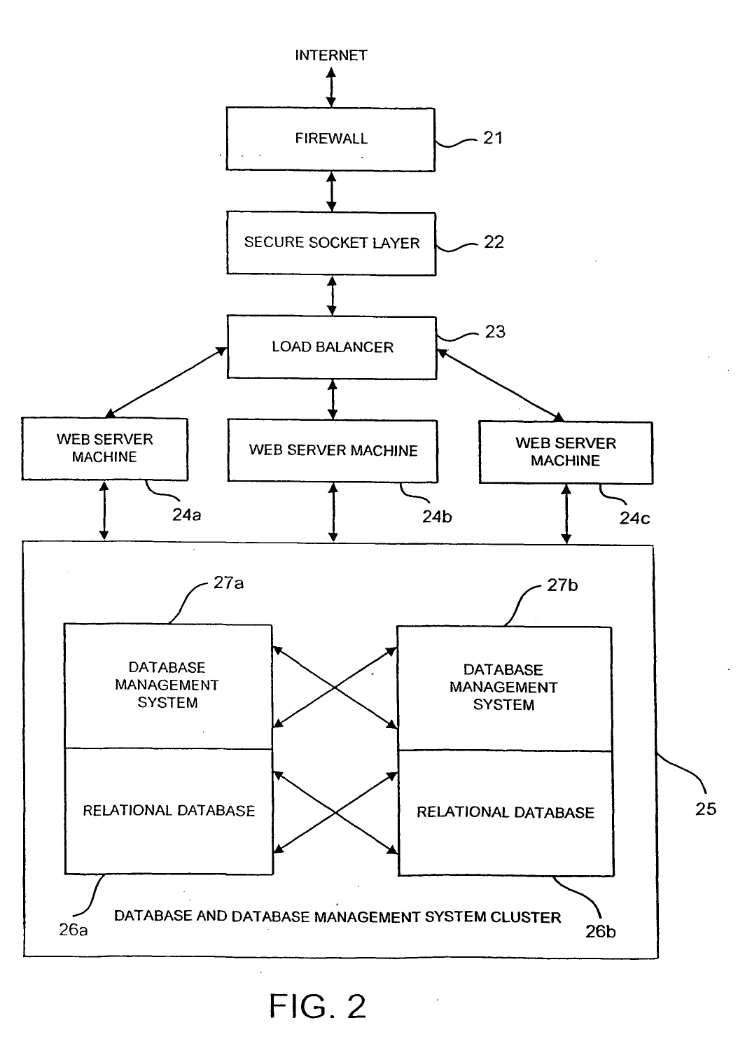

FIG. 2 depicts schematically the architecture of the hardware and software modules of the bet matching system and order set up and matching system shown in FIG. 1;

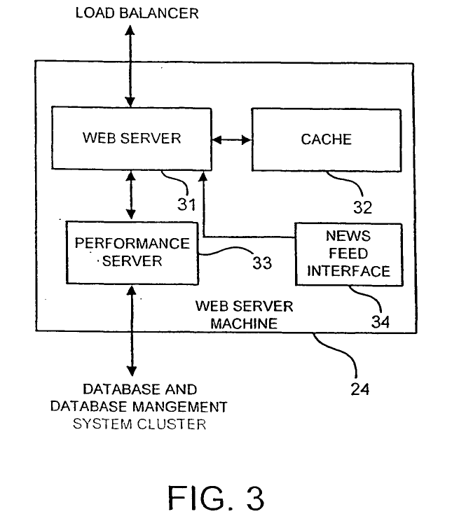

FIG. 3 depicts schematically the functional units of web server machine included in the system of FIG. 2;

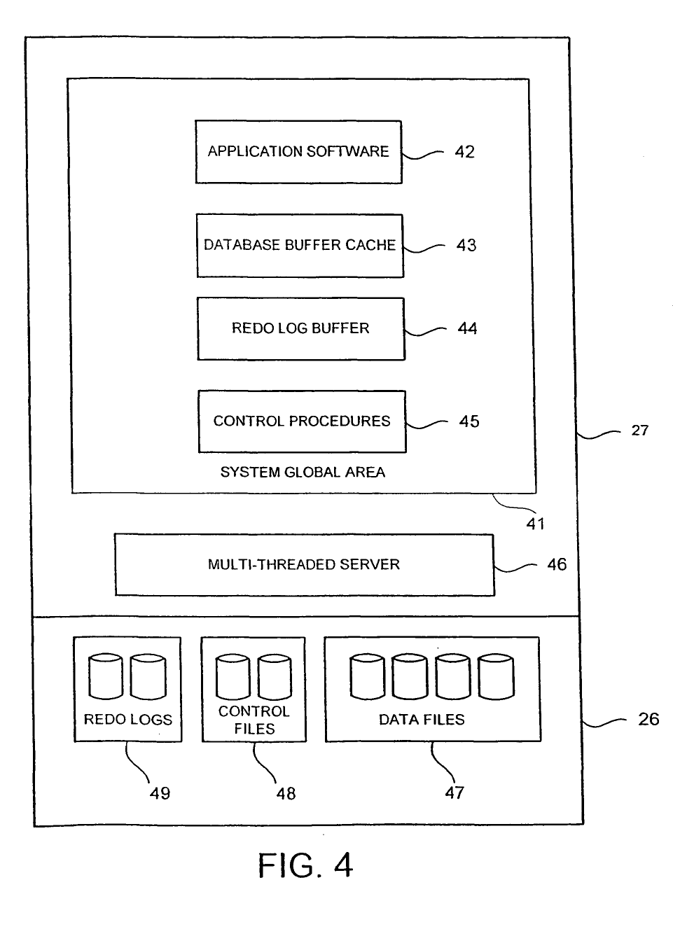

FIG. 4 depicts schematically the database management system and relational database included in the cluster shown in FIG. 2;

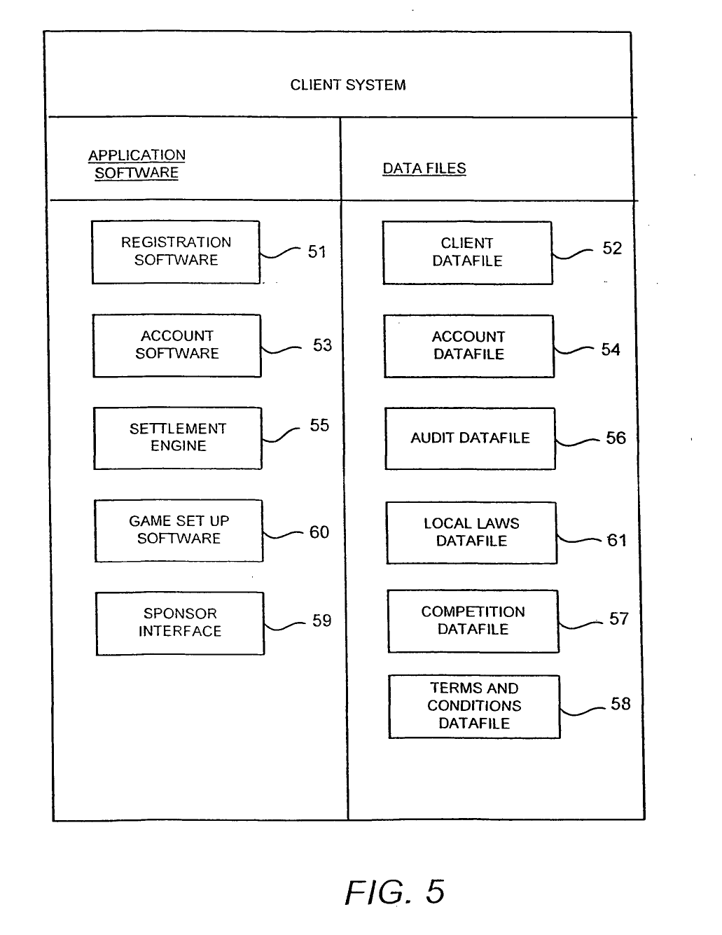

FIG. 5 depicts schematically the functional units in the application software included in the system global area of the database system shown in FIG. 4 in the client systems shown in FIG. 1;

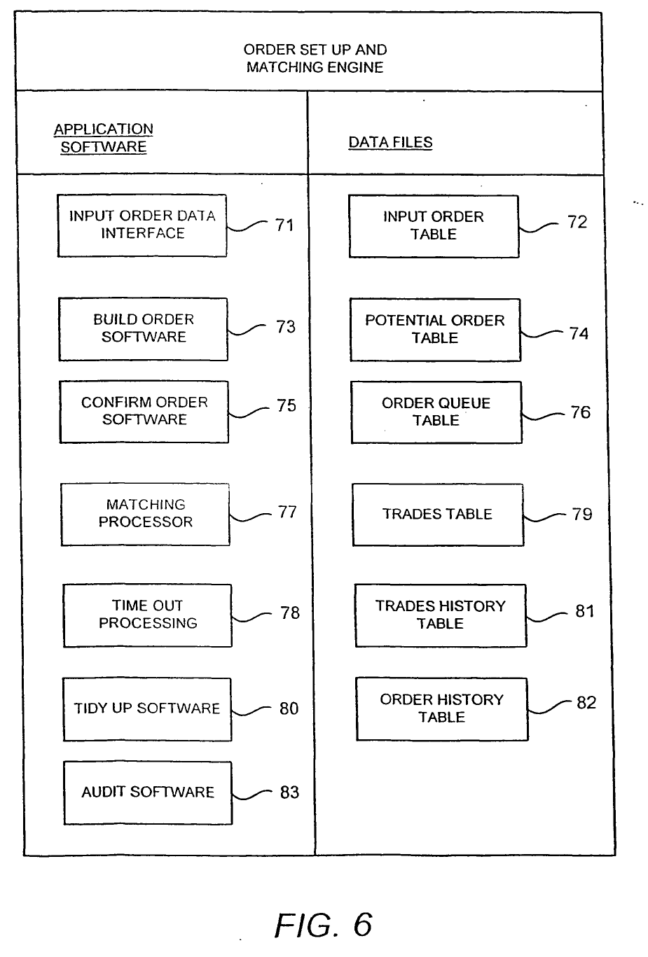

FIG. 6 depicts schematically the application software and corresponding data files in the order set up and matching engine incorporated in the order set up and matching system of FIG. 1;

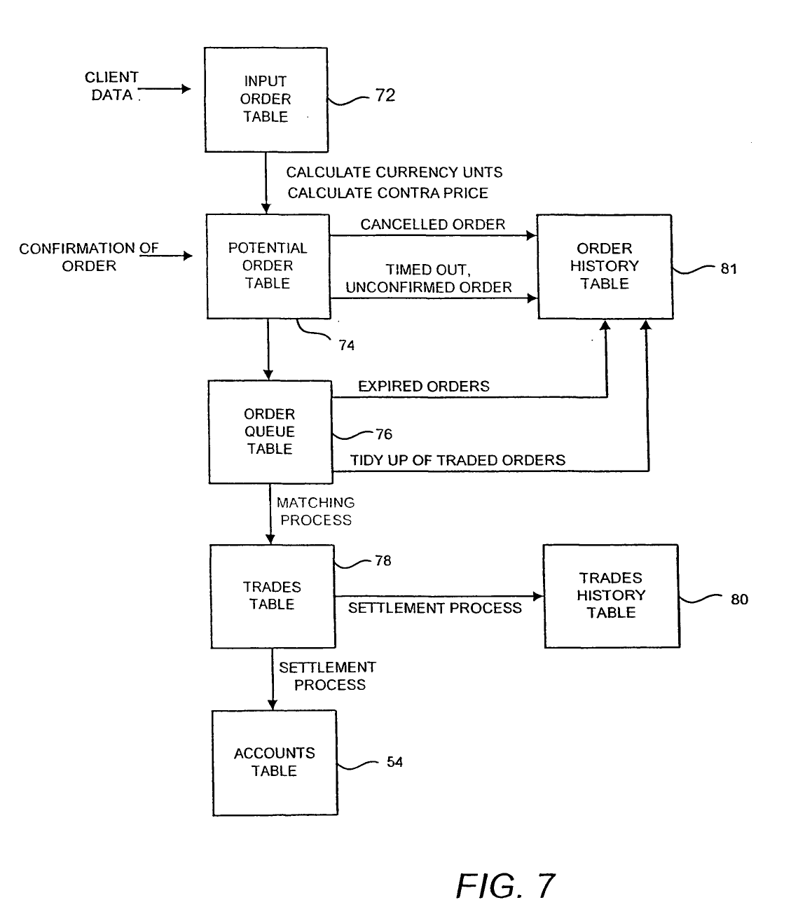

FIG. 7 illustrates the data processing flow between the various data files during the placing of an order and the subsequent matching and settlement process.

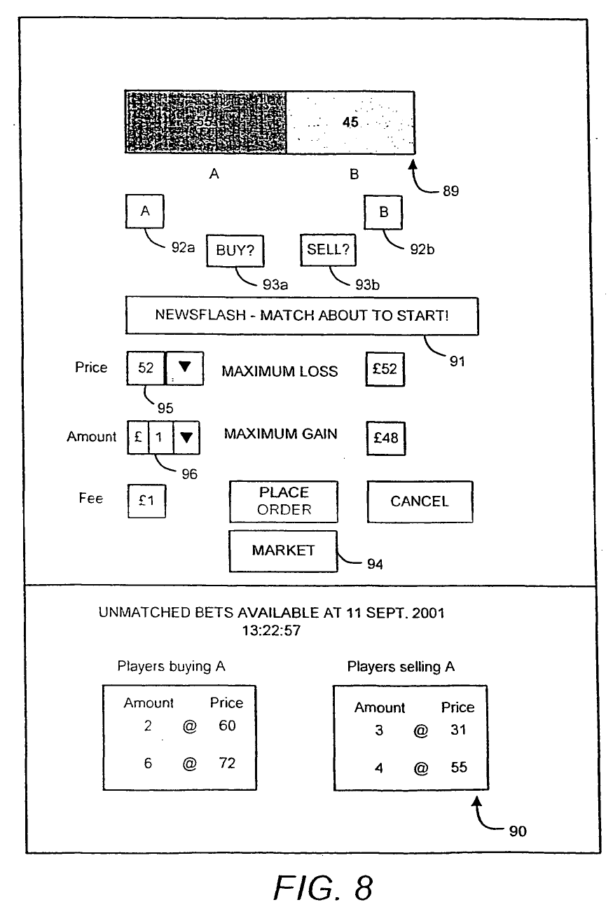

FIG. 8 illustrates a web page enabling the client to set up an order for a bet;

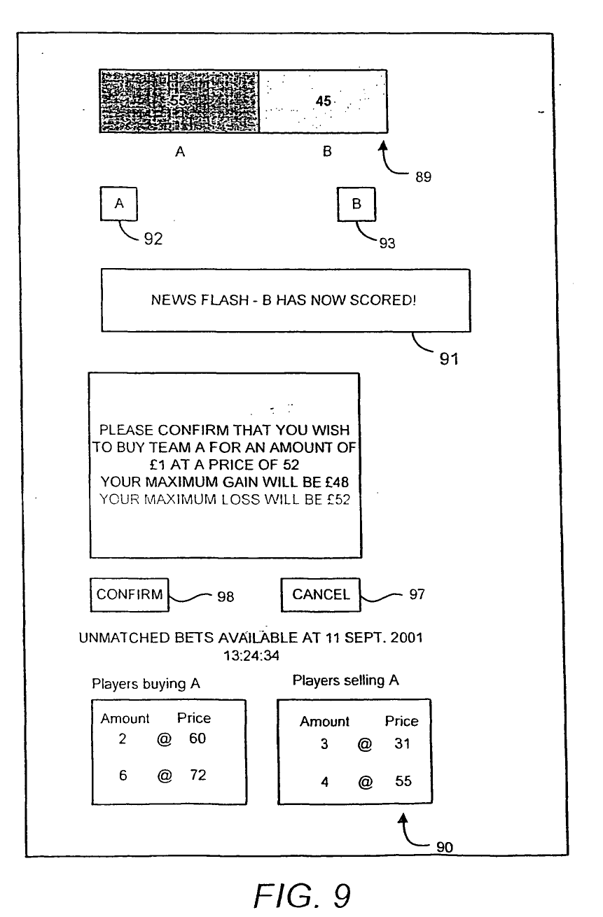

FIG. 9 illustrates a further web page used in the order set up procedure;

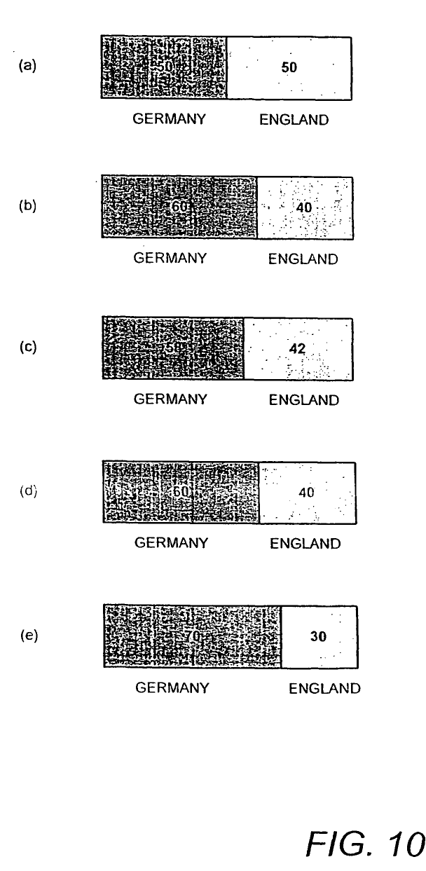

FIG. 10 illustrates the term of a bar chart illustrative of the last matched bet at various times in a bet matching process for a particular event;

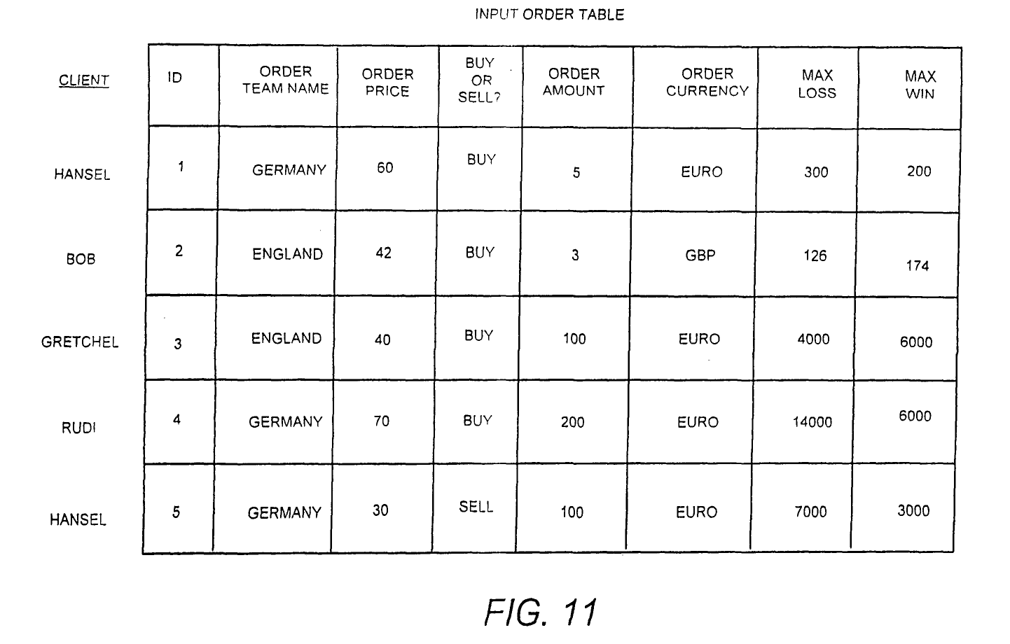

FIG. 11 is an illustrative example of an input order table for setting up orders for the particular event;

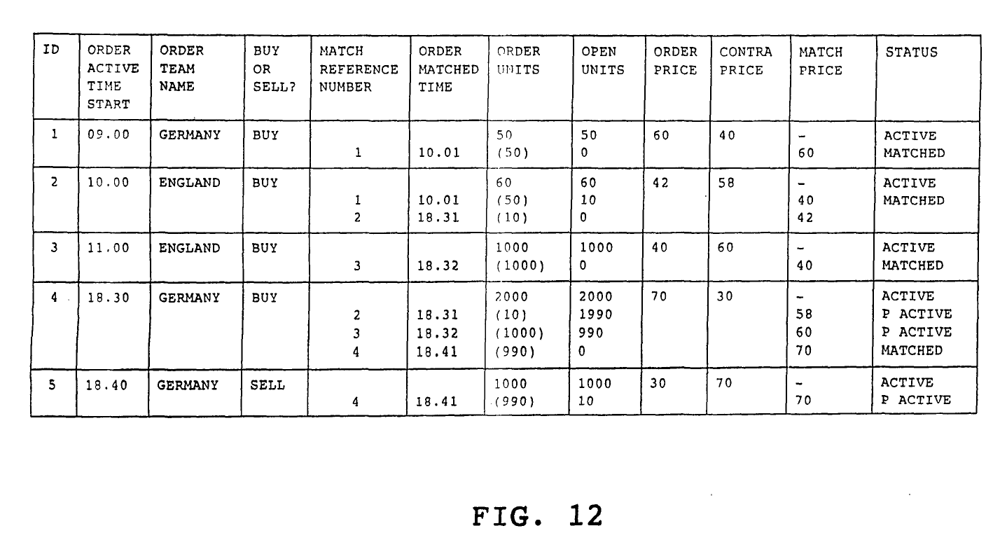

FIG. 12 is an illustrative example of an order queue table using information from the input order table of FIG. 11 in a bet matching process.

### OVERVIEW OF THE BET MATCHING SYSTEM

Referring firstly to FIG. 1, this drawing gives an overview of the bet matching system in operation. In the particular example depicted in FIG. 1 there are shown five terminals 1, 2, 3, 4, 5 though which five respective users may interact with the bet matching system, shown as distributed systems 6, 7, 8, via the Internet 9.

The basic requirement for each client is that they are provided with a means for entering data such as a keyboard, a display and a means for providing information to and receiving information from the Internet. The bet matching system creates web pages which may be accessed by the clients, the web pages enabling each client to register with the bet matching system, set up and deposit money in an account, select an event on which to bet, and place a bet on the outcome of a particular event at an odds chosen by the client, and at a stake chosen by the client.

In the particular embodiment to be described, the web pages include a visual indication of the last matched bet, and a table of unmatched bets, this enabling a client to have some idea of whether any particular bet is likely to be successful. The order set up and bet matching system registers the bet, determines whether the bet can be matched completely or partially by an earlier registered unmatched bet or bets and if partially or completely unmatched keeps the bet in the register of unmatched bets for matching with subsequent bets.

It will be appreciated that whilst only five client terminals are shown, in practice, there will be typically up to 100000 clients using the system at any one time. Also whilst only two bet matching system client systems for respectively the UK and Germany are shown, there will typically be one or more client systems in each of a large number of countries. Alternatively a single client system may be provided for clients worldwide at a single location, with the order set up and matching system optionally being provided at the same single location.

In the particular example illustrated on FIG. 1 the first terminal takes the form of a WAP phone 1 connected to the Internet 9 via a telephone network 10.

The second terminal takes the form of an interactive TV 2 connected to the Internet through a broadcast system 11. The third and fourth terminals are in the form of personal computers 3,4 including browser software and connected to the Internet 9 via respective Internet service providers 12 and 13.

The fifth terminal is a phone connected to the Internet via a call centre 14, the call centre being arranged to access the web pages, and produce information indicative of the information on each web page on the display of the phone, and in response to information typed on the keypad of the phone, pass HTML data to the Internet 9 for transmission to the bet matching system.

Turning now to the bet matching system, in the particular example shown in FIG. 1, the UK and German client system modules 6,7 are each primarily concerned with client registration and client accounts in the UK and in Germany respectively as will be described in more detail later. The separate order set up and matching system 8 will also be described in more detail hereafter. The bet matching system modules 6,7, and 8 will generally be connected through the Internet 9, with a high speed encrypted lease line connecting each module 6,7,8 to the Internet, although other means of connection can be envisaged including direct links between the client systems 6,7 and the order set up and matching system 8.

Architecture of the Bet Matching System

As mentioned in relation to FIG. 1 the bet matching system is spread over several functional units, in particular to client systems 6,7 and a order set up and matching system 8. However each of the functional units is run on effectively the same hardware and in order to improve flexibility and take advantage of economies of scale all the software will be loaded on each functional unit, with those software units which are not being used being disabled. This will enable the system to be adapted dependent on circumstance, for example if a competition is being held of interest to residents of only one particular location such as a particular country, it may be convenient for the order set up and matching system to be incorporated in the same place as the client system of that country.

Turning now to FIG. 2 each functional unit 6,7 or 8 basically comprises an interface to the Internet, units for supporting the web pages displayed to the clients, and a cluster of relational databases and associated database management systems for handling the information.

The signals coming in from the Internet will be in the form of HTML, XML or other markup language dependent on the type of terminal 1-5 and includes data representative of the information entered by the clients at their terminals 1-5 in response to registration forms either during the registration and account set up procedure in the case of the client systems 6,7 or in response to prompts on a web page for enabling the placing of an order to place a bet in the case of the order set up and matching system 8. The data passes through a fire wall 21 provided to protect against hackers in known manner. A secure socket layer 22 is provided to decrypt encrypted data where the data is for example account data, unencrypted data passing straight through the secure socket layer 22. A load balancer 23 is provided to distribute the incoming data between a number of web server machines, only three such machines 24a,24b,24c being shown in this example. It will be appreciated that the number of web server machines will depend on the expected traffic.

The outputs of the web server machines 24a,24b,24c are directed to a database and database management system cluster 25 containing, in the example illustrated, two linked relational databases 26a,26b with database management systems 27a,27b.

It will be appreciated that whilst two databases 26a,26b each with a respective associated database management system (27a,27b) are shown in FIG. 2, in practice any number of databases and management systems may be used depending on the expected data traffic for the bet matching system.

The databases for this particular example are chosen to be Oracle databases as these can be made suitable for use in a multi-user access system, Oracle databases having a clustering facility allowing multiple databases to be used with the input data being synchronised on an almost real time basis.

Features of Oracle databases and associated database management systems are described for example in “Oracle Essentials—Oracle 9i, Oracle 8i and Oracle 8” by R. Greenwald et al, second edition, published by O'Reilly, June 2001. Only those features of the database and database management system as will be needed to explain the embodiment of the invention, will be described.

It will be appreciated that other relational database systems can be used for example the IBM DB2, or the Infomex System.

The database management system 27a,27b stores various control procedures controlling the data input and output together with the bet matching system processes which, in this particular example, will be peculiar to either the client system 6,7 or the order set up and matching system 8. These are programmed into the database management systems 27a,27b using PL/SQL a procedural language extension to Structured Query Language and will be described in more detail later in relation to the particular functions performed by the client system 6,7 and the order set up and matching system 8. The data stored in the relational databases 26a,26b for the client system 6,7 and the order set up and matching system 8 will also be described in more detail hereafter.

Turning now to FIG. 3 this figure describes the general architecture of each web server machine 24a,24b,24c. The output of the load balancer 23 is input to a web server 31 which in turn is connected to cache memory 32 and a performance server 33. Each web server machine 24a,24b,24c is also provided with a newsfeed interface 34 to which current information relating to currently running events, for example a football match, can be fed from an outside news agency, for incorporation on the latest web pages.

The web server 31 is effective to support web pages on a web site for the bet matching system. It is possible to categorise each web page as either:

i) static, where for example a client has requested general information relating to the bet matching system such as terms and conditions. These pages can be stored and retrieved from the cache 32; or

ii) semi static or dynamic in which the pages must be updated in response to a incoming request after retrieving data stored in the databases 26a,26b and/or processing data in the database management system 27a,27b.

It will be appreciated that such an arrangement avoids the necessity of interrogating the databases 26a, 26b for each incoming request, thus speeding up the system particularly as it is found that a significant proportion of incoming requests relate to activities such as viewing competition information or viewing terms and conditions which are contained on static web pages which may be stored in the cache 32. More details of such an arrangement are described in International Patent Application WO-A-01/33388.

The performance server 33 is also effective to interrogate the incoming information to determine whether the information has originated from a PC, an interactive TV, a WAP phone or any other terminal configuration. This enables an appropriately addressed return message to be generated. The performance server 33 is also effective to perform a parsing process to determine from the universal resource locator (URL) of the incoming HTML signals, the country from which the request has originated. This enables a response to be sent back including an appropriate choice of languages to be offered to the clients.

Where it is determined that it is necessary to interrogate the database 26a,26b, the data is passed by the performance server 33 to the database and management system cluster 25.

Turning now to FIG. 4 this figure illustrates schematically the basic processing units stored in each database management system 27 together with the file structures on the data stored in each relational database 26. The modules included in the database management system includes an area of memory known as a System Global Area 41 including an area 42 in which application software such as the bet matching system application can be written using the PL/SQL programming language. The application software for each functional module in the bet matching system will be described in detail hereafter. The System Global Area 41 also includes a database buffer cache 43 in which a copy of the most recently used data is stored, this avoiding the necessity of always reading data from the data files 47 and a redo log buffer 44 whose function will be described hereafter.

Finally the System Global Area 41 includes a set of control procedures 45 including data-file access software for controlling the input and output of data by the data files 47, core procedures and cluster software for controlling the replication of data between the individual databases 26a,26b in the cluster in a manner which will be known to those familiar with Oracle databases.

The data management system 27 also includes a multi-threaded server 46 including a large number of CPUs designed to carry out processes designated in the System Global Area 41 stored procedures. It is a particular feature of such a server 46 that each process uses any available CPU amongst a number of CPUs, the embodiment of the invention being arranged to perform processes in a sequence of short processes in order to make best use of the multi-threaded server 46.

Each database 26 includes a series of disks on which the data is stored. In addition to the data files 47, the database includes control files 48 and re-do log files 49. The control files 48 contain a list of all the other files that make up the database such as the data files 47 and the re-do log files 49 and contain information about the contents and state of the database such as the name of the database, the current state of the data files, whether they need recovery, whether the database closed cleanly the last time it was shutdown and what back-ups have been performed. The re-do log files 49 store a recording of the changes made to the database as a result of transactions and internal database activities. The re-do log buffer 44 within System Global Area 27 caches re-do information until it is written to the physical re-do log files 49 stored on the disk avoiding the necessity of constantly writing the re-do logs to disk. Re-do logs thus enable recovery in the event of a failure to record changes on the data files 47 on, for example, failure or shutdown of the system.

Software and Data Files Incorporated in the Client System

FIG. 5 illustrates schematically the functional units of the application software 42 and the contents of the corresponding data files 47 which are included in the bet matching system client systems 6,7.

The application software 42 includes a registration software module 51, this being arranged to write data into a client database 52 within the data files 47.

The application software 42 further incorporates account software 53 enabling account data to be written into an account database 54 in the data files. There is also provided a settlement engine 55, which in this particular example is included within a client system 6,7 but could either additionally or alternatively be included in the order set up and matching system 8. The settlement engine 55 also provides a flow of information to an audit datafile 56 within the data files 47.

In the particular bet matching system being described, a bet matching competition to be run on the bet matching system for any event may be sponsored by one or more sponsors who run the system for that particular event, for example The Ryder Cup. This bet matching system may act in either a gaming or a gambling mode. In a gaming mode there may for example be offered prizes rather than cash from the system, in which case the account system will be run on the basis of “virtual” rather than “real” money. The datafiles thus include competition datafiles 57 for a particular competition which takes account of how the competition is set up, and a data file 58 including terms and conditions for the particular game, including what happens to orders for bets if an event is cancelled or postponed, what happens if the outcome of an event is a draw. The terms and conditions will also include information relating to the fee, if any, taken from the client by the sponsor running the competition. It is a feature of the particular embodiment of the invention being described that matching of bets between different competitions run by different sponsors can be achieved if required. A sponsor interface 59 is provided to enable input and output of information from the sponsors, a game set up software module 60 enabling the stored competition data in the competition data file 57 and the terms and conditions in the terms and conditions data file 58 to be adjusted to fit the particular competition.

Each particular client system 6,7 may also include a local laws datafile 61 for the particular client system, this taking account of local laws relating to data protection which may affect the way in which the data is set up and recorded in the client datafile 52 and also any local regulations, for example prohibiting gambling as opposed to gaming. Local tax regulations may also be incorporated in the local laws datafile 59, this having an effect on the amounts paid back to a client winning a bet.

Application Software Included in Order Set Up and Matching System

Referring now to FIGS. 6 and 7, Figure illustrates the application software 42 incorporated in the System Global Area 41 for the order set up and matching system 8, together with the associated datafiles incorporated in the database 26 for the order set up and matching system 8, whilst FIG. 7 illustrates the information flow between the various data files. The application software 42 includes an input order data interface 71 effective to receive incoming bets entered by a user at their terminal 1 to 5 and enter the data into a input order table 52 stored within the datafiles 47.

A further build order software unit 73 is arranged to perform various operations on the input order table data and store the processed data in a further enlarged table called potential order table 74. A further processing module 75 comprises software arranged to confirm the order dependent on information received from the client, and copy the confirmed order into a further table called an order queue table 76. The application software also includes a matching processor 57 which acts on the data stored in the order queue table 76 to match bets, details of the matched bets being entered in a trades table 78 datafile within the data files 47.

A separate processing unit for performing time out processing 78 is provided to provide a time out function where orders are not confirmed within a reasonable time, or orders are not matched either within a period set by a client, or within a reasonable time. A tidy up software module 80 is arranged to delete entries from the various tables which are no longer needed, for example after operation of the time out function, or in the order queue table 76 after matching of an order.

Finally the application software includes audit software 79 for producing an audit trail from the various transactions which are stored in the trades history file 80 and the order history file 81.

The interaction between the various software modules and datafiles will be described in more detail hereafter in relation to a particular example of a bet placed by a client.

Registration Procedure

On first logging on to the system via their terminal 1 to 5, the client enters the relevant universal resource location (URL) for the home page (not illustrated) of the bet matching system, this being directed by the Internet to the firewall 21 and passing through the secure socket layer 22 to be directed by the load balancer 23 to a web server machine 24a,24b,24c. The web server within the chosen web server machine 24a,24b,24c retrieves the home page from the cache 32, the performance server having interrogated the IP address of the incoming request to determine the type of originating terminal 1 to 5 and the country of residence of the client to send the home page back in a format for the particular terminal 1 to 5.

If the client wishes to register with the system, he then selects the relevant button on the home page to request the registration page, this request then being sent back through the system to the web server 31 which retrieves the relevant registration web page (not illustrated) from the cache 32 and transmits this to the particular client terminal 1 to 5 either directly where the terminal is a PC, WAP or interactive television, or indirectly in the case of a phone/call centre combination.

The registration web page presents a form in well known manner to the client in which the client is invited to fill in his name, address and contact details, an applet downloaded with the web page and running on the client browser performing a first check on the formatting of the data entries. The information is passed as HTML data back to the client system where it is determined within one of the web server machines 24a,24b,24c using the performance server 33 whether the client data is complete. If there is any query, a query is sent back through the Internet to the client, the client being invited via the web page to revise his entries.

On receipt of correct client data the web server 31 retrieves the web page indicating terms and conditions of the bet matching system from the cache 32 and directs this back to the client terminal. When the client has indicated via a button on the terms and conditions web page his acceptance of the terms, this information is directed back through the web server 31 to the performance server 33 and the information is passed to the registration software 51 within the application software in the client system, database management system 27 and entered in the client datafile 52.

A web page is then sent to the client inviting the client to set up an account, the client being invited to fill in appropriate information on a web page and either by a debit or credit card payment or bank account details place money into an account with the bet matching system using the account software 53 and account datafile 54. It will be appreciated that such account data will generally be in encrypted form and will thus be intercepted by the secure socket layer 22 for decryption.

Placing of an Order

FIG. 8 shows one example of an order set up web page, although it will be appreciated that the form of the web page will depend on the particular competition etc.

After successfully registering with the betting matching system and placing money in an account with the bet matching system, the client is then able to access and, for example a pull down menu, an order set up procedure web page of the form shown in FIG. 8 or similar. In the particular example shown, the client is able to place a bet on the outcome of a sporting event that is a win by team A or a win by team B.

It is a feature of the particular embodiment being described that the probability of an outcome such as team A winning is expressed in integer values between 0 and 100. Zero means that team A has no probability of winning. A probability value of 100 means that team A will definitely win. Thus the extra odds on team B winning is 100 minus the probability of team A winning. Clients are invited to place a bet “buying” team A or team B at a “price” representing their expectation of that team winning. Alternatively, a client may “sell” their chosen team, this being the equivalent of a “buy” of the opposite team. The last matched bet, that is a bet backing team A at a particular number of probability units matched by a opposing bet backing team B is illustrated on the web page by means of a bar chart 91. In the particular example shown, a bet backing team A at 55 probability units has been matched by a counter-bet for team B at 100 minus 55 probability units, that is 45 probability units. It will be appreciated that the choice of a scale between 0 and 100 is arbitrary, any scale can be used. However a scale of integers between 0 and 100 enables losses and gains to be readily calculated as will become apparent later.

Whilst the bar chart 89 provides to the user some indication of what bets are currently being matched, the client is free to choose any particular probability for a selected team to win. In order to assist the client further in selecting a “price”, i.e. the number of probability units, the web page may also display a table 90 indicating unmatched bets available at the time that the web page cache 32 in the web server machine 24 at the order set up and matching system 8 were last updated, this being conveniently included in a dropdown page. Thus if a client wishes to match a particular unmatched bet, if he acts very quickly he may be able to catch the unmatched bet before it is matched by the matching processor 77 with a subsequent incoming bet from a different client.

The web page may also be provided with a display 91 which displays the latest information received at the web server machines 24 via the newsfeed interface 34 relating to particular match A versus B.

In order to select team A or B the user presses a button 92a or 92b and is then able to choose to “buy” or “sell” the selected team using buttons 93a, 93b. The web server machine 24 transmits a further web page causing a message 94 to appear asking the client to enter details to “buy” the selected team (team A in this case) and confirm the placement of the order. It will be appreciated, however, that where the terminal is a PC, an applet may be downloaded from the web server machine 24, which runs on the client's browser. The client is then able to select the number of probability units or “price” by, for example, means of a scroll down menu 95 on the order form or in an alternative web page format by typing in the amount. The client then uses a further scroll down menu 96 to select the stake. In the particular system being described, the stake, is a unit price or “amount” times the number of probability units. In this particular example the client is placing an order for a bet at a “price” of 52 units, each unit being one GB pound. The web page furthermore may include a window informing the client that there is a fee of, for example, £1 for using the betting service, where such a fee is being charged.

The web server machine 24 is then arranged to determine the maximum loss and the maximum gain for that particular bet. In this particular instance where the client has bet 52 units on team A winning the maximum loss is £52 while the maximum gain is £48.

In an alternative mode of play actuated by button 94, a client may choose to enter a bet in which his bet is matched at the best possible price by an existing unmatched bet. The client may stipulate a particular price with a tolerance to exceed that price by a certain number of points.

In either mode of play, the client may also choose to put a time limit on their offer.

Referring now also to FIGS. 6 and 7 again, the client data is entered via input order data interface 71 into the input order table 72. The input order table 72 will include data fields of the form shown in the following table.

INPUT ORDER TABLE

| Field Name | Example |
|---|---|
| Order Contract Identifier | 100012 |
| Order Price | 52 |
| Order Ambunt | 1 |
| Order Maximum Win Potential | 48 |
| Order Maximum Loss Potential | 52 |
| Order Team Name | A |
| Order Currency | GBP |
| Order IP Address | 92.168.23.48 |

The order price, order amount, order maximum win potential, order maximum loss potential, order team name and the order currency are all directly derived from the information generated by the client. The order contract identifier is an internal reference to the trading contract and is generated by the bet matching system. The order IP address is determined by the performance server 33 in the web server machine 24 from the incoming message.

The system then uses the information now included in the input order table 72 and from other parts of the system, in particular the account data file 54 and the client data file 52, to build a potential order table 74 as will now be described.

In the first instance the system determines using the account datafile 54 whether the client has sufficient funds in his account to meet the maximum loss potential and if not an appropriate message is sent back to the client's terminal. The amount in the input currency for example GB pounds is converted to a number of bet matching system points at a particular exchange rate, for example 20 units to the GB pound. This then enables the order matching to match an order in GB pounds to an order in another currency, for example Euros or US Dollars. The system also calculates a contra order price for team B as this is the bet to which the order will be matched. The time and date at which the order was entered is set as a field, together with a number of empty timing fields which will be used during the subsequent matching process.

The following table indicates the major data fields which are inserted into the potential order table in addition to those in the input order table.

ADDITIONAL FIELDS ADDED TO PRODUCE
POTENTIAL ORDER TABLE

| Field Name | Example |
|---|---|
| Order Reference (ID) | 1123567 |
| Order Amount (Points) | 1040 |
| Order Outstanding Amount (points) | 1040 |
| Contra Order Price (points) | 1040 |
| Order Team Reference | 134566 |
| Buy or Sell? | Buy |
| Order Contra Team Name | B |
| Order Contra Team Reference | 134567 |
| Order Active Time Start | 12/9/01; 19.33 |
| Order Active End (date, time) | 12/9/01; 21.33 |
| Order Entered (date, time) | 12/9/01; 19.00 |
| Order Confirmed (date, time) | 12/9/01; 19.10 |
| Order Matched (date, time) | |
| Order Part Matched (date, time) | |
| Order Timed Out (date, time) | |
| Order Cancelled (date, time) | |
| Order Traded (date, time) | |
| Trade Number | |
| Competition reference | matchABtournament |
| Contract Reference | 7235 |
| Competition Registration | 1565223 |
| Order Status | ACTIVE |

The client is then invited on a further web page as illustrated in FIG. 10 to either confirm or cancel the order. If the order is cancelled the entry in the potential order table is passed to the order history table 81. Similarly, if the order is not confirmed within a reasonable amount of time (which may be the end of the match), the time out processing unit causes order is flagged as being timed out and is moved by the tidy up software to the order history table 81.

Assuming that the client has pressed the confirm button 98 on the web page shown in FIG. 9, the order passes to an order queue table which includes all pending orders and is a copy of the potential order table other than for any cancelled, or timed out non-confirmed orders.

The matching processor 77 is then effective to compare the latest placed bet against the orders stored in the order queue table 76 in order to determine whether the current bet can be matched. This is done by comparing the contra price field as entered in the potential order table 74 against the order price for team B in the earlier registered bets. The matching processor 77 is arranged to find the earliest bet backing team B at the highest price greater than or equal to the contra price for team B of the current bet. Thus this ensures that the current client has the cheapest possible take up for the present client. If the bet is matched the status is changed to matched and the entry is flagged such that in the subsequent tidy-up of trading orders the entry is cleared to the order history table 81. It will be appreciated that the earlier bets may not match the total stake of the current client as determined by the amount he has staked per probability unit. Thus the order may have its order status changed to partially matched and remain in the order queue table to have the remains of the bet matched against future incoming bets. Orders which are never matched but have expired, for example due to the end of the event or due to a time limit entered by the client, are also flagged by the time out software and sent to the order history table by the tidy up software. Further details of the order matching process will be given in an example to be described later.

Entries which have been flagged as matched are transferred to a trades table 78 to await the outcome of the event, i.e. whether team A or team B wins, following the resolution of the event the information in the trades table being passed to the settlement engine 55 which in this particular example is shown in the client system such that appropriate funds can be released to the client who has placed the winning bet. The outcome of the settlement process is recorded in the accounts datafile 54 in the client system.

Finally, the outcome of the settlement process is also recorded in the trades history table which gives an indication of the trades which have been performed for audit purposes.

The system is arranged such that most of the processing procedures will be performed whilst the client is entering the relevant data into the order web page, and subsequently actuating the confirmation button on the confirmation web page giving the impression of an instantaneous process. Thus by the time the client has looked at the subsequent web page (not illustrated) indicates that the order has been accepted, his order may well have been matched. In order to determine whether his order has been matched, the client is able to call a further web page which gives a list of his traded orders. Alternatively, within his registration details, the client may indicate that he should be contacted by a message, using for example the short message service, to the effect that the bet has been matched.

It will be appreciated that the bet matching processor 77 acts as a state machine, with the system being at rest until the next incoming bet acts as an aggressor causing the matching processor to act.

The bet matching processor operates using a single CPU per competition to avoid discrepancies in the matching process. The system is therefore designed to reduce the load on the matching processor. In particular, the bet matching processor operates by means of indices within the order queue table to rapidly identify the critical fields such as the order contra team reference and the contra price which are matched with the previously recorded orders. It will be appreciated that as this information is included in final format within the order queue the amount of processing which the matching processor has to perform is minimised so speeding up the matching process. It will also be appreciated that the separate time out and tidy up modules reduces the work which must be performed by the matching processor 77, these software modules being run periodically.

Illustrative Example of Ordering and Matching Processes

Referring now to FIGS. 10, 11 and 12, these figures give an illustrative example of the placing of a number of bets on the outcome of a particular football match between Germany and England and the subsequent bet matching process. In the particular example to be described it is assumed that there are no existing orders for the particular competition in the order queue table. It will be appreciated however, that in practice the betting may be initiated by a system administrator known as a market maker who will put in two opposing bets to start off the system.

In the particular example being shown, in the absence of any pre-existing bets, both Germany and England are assumed to have the same probability of winning and thus the order bar 89 shown on the web pages illustrated in FIGS. 8 and 9 is set at 50:50 as shown in FIG. 10(a).

Referring now also to FIGS. 11 and 12, FIG. 11 indicates the information entered into the input order table for the competition, whilst FIG. 12 illustrates a number of fields in the order queue so as to explain the matching process. The first bet to be entered by the system by a particular client, Hansel, who places an order to “buy” Germany to win at 5 Euros per unit at a price of 60. This order is input via the order web page as previously described in relation to FIG. 8. As previously described, the web page displays the maximum loss for the order of 300 Euros and a maximum win of 200 Euros and invites Hansel to confirm the order.

Assuming that Hansel has sufficient funds to match his maximum potential loss in his account as recorded in the account datafile 54, the order will progress to the potential order table 74. At this point the order will be translated into order units. In this particular example it is assumed that each Euro is equivalent to ten units. Thus an order unit of 5×10 is calculated and entered as 50 order units in the potential order table. The number of outstanding units is also set at 50. The contra price is entered as 100-60, that is 40. The status of the order is set as “active”. On confirmation of the order by Hansel, the information is transferred to the order queue table 76. As there are no pre-existing bets against which to match this bet the order is merely recorded in the order queue table to await the next incoming order.

In the particular example the next bet is made by Bob who wishes to “buy” the England team at an order price of 42 at an amount of £3. The system thus enters a maximum loss £126 with a maximum win of £174 in the input order table 72. Assuming that the exchange rate is set at 20 units per GB pound, the number of order units then entered into the potential order table and subsequently the order queue is 3×20, that is 60 units. The outstanding units are also 60 units. A contra price of (100-42), that is 58, is entered.

The matching processor 77 searches the unmatched order queue for active offsetting orders with an order price equal to or greater than the contra price, selecting the highest available order price.

There exists a match with an order price on Germany of 60 for the trade amount of 50 units. A match is effected which will fully match Hansel's order and partially match Bob's order at the order price of 60 giving Bob a match price of 40 which is a better price than his order price. Thus Bob's order can be updated to 60-10, that is 10 outstanding units, and be set to partially active but still with an order price of 42. As Hansel's order has been fully matched, the order having no outstanding units, the status is changed to matched. In due course Hansel's ID Number 1 is removed from the order queue by the tidy up software 80 and transferred to the trades table 79 to await the settlement process.

Referring now to FIG. 10(b), at this time there has now been a matched bet of Germany 60, England 40. Thus the bar chart displayed on the web pages is changed to reflect this.

The next person to place a bet is Gretchel who places an order to “buy” England at an order price of 40 and an order amount of 100 Euros. The maximum loss for Gretchel is thus 4000 Euros with a maximum win of 6000 Euros. Assuming that Gretchel has sufficient funds in her account to cover the potential maximum loss, this information is included in the potential order table together with a calculated number of the amount of order units of 10×100, that is 1000, and that an outstanding units amount of 1000, a contra price of 100-40, that is 60. The status of the order is then marked active.

After Gretchel has confirmed the order via the confirm button, this order is entered in the order queue. As there are no possible matching bets against Gretchel's order, this bet remains in the order queue to await subsequent incoming bets.

As the match Germany versus England proceeds, there is a newsflash that Germany has scored a goal which is displayed in the window 91 on the bet matching system web page. This increases confidence in the German team and Rudi places an order “buying” Germany at an order price of 70 at an order amount of 200 Euros. This thus gives Rudi's order a maximum loss potential of 14000 and a maximum win potential of 6000 Euros.

Following confirmation, Rudi's order proceeds into the potential order queue, the order units of 2000 are entered, that is 200×10 at a contra price of 30, and the order is marked active. It is possible to match this order against the order price of England 42, Germany 58, at the trade amount of 10 thus fully matching Bob's active offer, this offer being at a better price for Rudi than Gretchel's partially active offer at 40. The 10 units are subtracted from 2000 to leave 1990 units in Rudi's order leaving the order with a partially active status. As the last matched bet is still now Germany 58, England 42, as indicated in FIG. 10(c) the bar chart configuration changes to display this.

A further part of the 1000 order units of Rudi's bet can then be matched against Gretchel's outstanding bet for another 990 units at Germany 60 England 40, the bar chart thus moving back to the configuration indicated in FIG. 10(d).

There is then a further newsflash that England have scored three goals in rapid succession. It is a feature of the system being described that Hansel who has already placed an order “buying” Germany, which order has been matched at a price of 60 for a total of 50 units, may wish to ameliorate his position in view of the strength of the English team and the likelihood of them now winning the match. To do this Hansel may place an order for a new bet, bet ID number 5, “selling” Germany at a price of 30 units at an order amount of 100 Euros. This gives a maximum loss of 7000 units and a maximum win of 3000 units. The account system is arranged to take account of Hansel's earlier order to determine that Hansel has sufficient funds in his account to proceed with bet order ID number 5. The new order therefore proceeds into the potential order queue with order units of 1000, outstanding units of 1000 and a contra price of 70. Within the matching processor 77, Hansel's sell order for Germany at an order price of 30 is treated as a buy order on England at an order price of 70. This latest bet can be matched at Germany 70, England 30 for the trade amount of 990 units against Rudi's outstanding, partially active bet thereby fully matching Rudi's bet and leaving Hansel with an unmatched bet of 10 order units. As there is now a trade, the matched order passes to the trading table awaiting outcome of the result of the match Germany versus England and as shown in FIG. 10(e) the bar chart configuration on the web pages changes to displaying Germany 70 England 30.

It will be that in the outcome of a win for England:

1. Hansel loses 50×60 units, that is 3000 units corresponding to 300 Euros on his first bet, but is able to ameliorate his losses by winning 990×(100−30) units, that is 69300 units corresponding to 6930 Euros on his second bet to make a net gain of 6630 Euros.

2. Bob wins 50×(100−40) plus 10×(100−42) units, that is 3580 units corresponding to £179.

3. Gretchel wins 1000×(100−40) units, that is 6000 units corresponding to 6000 Euros.

4. Rudi loses 1000×60 plus 10×58 plus 990×70 units, that is a total of 129880 units corresponding to 12988 Euros.

Thus the amounts won and lost during the competition have been balanced.

It will be appreciated that whilst the particular display of the probability on the outcome of an event shown in FIGS. 8, 9 and 10 is in the form of a bar chart, which is a particularly clear representation of the probability odds on a particular event, other representations may be used, for example pie charts, pendulums, or simply numbers with descriptive text.

It will also be appreciated that whilst for clarity of explanation the examples given herebefore are in respect of two opposing teams, the invention is also applicable to events in which there are multiple players, for example horse racing or car racing.

It will be appreciated that whilst the invention has been described in terms of hardware and software modules, the invention may be implemented by a computer program including processor readable instructions for causing suitable processors to perform the invention. The computer program may be stored on a storage medium, for example a CD ROM or downloaded as a signal from, for example, the Internet.

1. A bet matching system comprising:
means for receiving from a communication network, data representative of a current bet placed on the outcome of an event, including an amount which the user wishes to stake;
means for storing said received data in a relational database system;
means for forming a match between said bet and an earlier stored bet on the reverse outcome for at least part of the stake at the best price for said current bet; and
means for storing data representative of the bet in respect of any unmatched part of the stake for matching against future bets in said relational database system.

2. A system according to claim 1, wherein said data representative of a bet includes the odds which the user wishes to take on the outcome of a particular event in terms of probability units representative of that outcome.

3. A system according to claim 1, in which said data includes a request to match the current bet against a range of at least some of the existing unmatched bets.

4. A system according to any one of the preceding claims, wherein said data includes a time limit in which said current bet may be matched.

5. A system according to any one of the preceding claims, wherein said means for receiving data comprises a web server means comprising:
means for generating one or more web pages inviting a user to enter said data representative of a bet;
means for receiving data entered by the web page by the user; and
means for directing said received data to said relational database system.

6. A system according to claim 5, wherein said means for generating comprises means for producing on said one or more web pages a visual indication of the probability units of the outcome on the last bet matched by said means for forming a match.

7. A system according to claim 5 or claim 6, wherein said web server means includes a cache memory effective to store web pages whose contents do not vary.

8. A system according to any one of claims 5 to 7, wherein said web server means comprises means responsive to data received from the communication network to determine the type of the user terminal generating the location; and
means effective to format said web pages according to said type.

9. A system according to any one of the preceding claims, in which said probability units are integer units between zero and 100.

10. A system according to any one of the preceding claims, wherein the communication network is the Internet.

11. A system according to any one of the preceding claims, wherein said means for storing data comprises means for storing said received data in a first data field;
said means for calculating is arranged to store the contents of said first data field and said data indicative of said contra odds in a second data field; and
said means for determining using the data included in said second data field.

12. A system according to any one of the preceding claims, in which said relational database system is a distributed system with relational databases being located in different locations and linked by a communication means.

13. A system according to any one of the preceding claims, comprising accounting means effective to convert said amount into a number of accounting units for use by said means for forming a match.

14. A system according to any one of the preceding claims, in which said relational database system includes a multi threaded server arranged to run software modules so as to act as said means for storing, said means for calculating and said means for forming a match.

15. A system according to any one of the preceding claims including an accounting means effective to store an indication of each user's potential liability for a bet including the potential liability on any earlier pending bets.

16. A method of use of a bet matching system according to any one of claims 1 to 15.

17. A computer program including processor readable instructions for performing a method according to claim 16.
